(19) United States
(12) Patent Application Publication
(10) Pub. No.: US 2018/0165418 A1
(43) Pub. Date: Jun. 14, 2018

(54) HEALTH RECOMMENDATIONS BASED ON EXTENSIBLE HEALTH VECTORS

(71) Applicant: Welltok, Inc., Denver, CO (US)

(72) Inventors: Jacque W. Swartz, Loveland, CO (US); Matthew Kellar MacLeod, Denver, CO (US); Paul Ingram, Poulsbo, WA (US)

(21) Appl. No.: 15/373,273

(22) Filed: Dec. 8, 2016

(51) Int. Cl. G06F 19/00

(52) U.S. Cl. CPC G06F 19/3431; G06Q 50/01; G06F 19/324

(57) ABSTRACT

A health recommendations system that collects data about multiple factors pertaining to an individual's health and uses such data to recommend contextual changes that are likely to have a positive health impact on the individual. The collected factor data is used by the system to generate a vector characterizing the health of the individual over time. Using the individual's health vector, the system generates a current health score of the individual, which characterizes whether the individual is healthy or unhealthy. By periodically assessing the health vector of the individual and generating health scores, the system also constructs a trend of the individual's health score as the individual's health varies over time. The system compares the individual's health score trend data with data reflecting the health score trend of similarly-situated people, and, based on that comparison, generates recommendations for actions or changes that the individual can take that are likely to improve the individual's health.

### BACKGROUND

It is well-understood that certain factors predictably impact the health and wellbeing of an individual. For example, the blood pressure of an individual, the individual's cholesterol level, and the individual's body mass index (BMI) all have known influences on the individual's health. In general the influences of these factors is generally consistent across a population of different individuals. That is, high cholesterol, high blood pressure, and being overweight are consistently associated with negative impacts on health. These factors may be difficult for an individual to control, however, and health improvement recommendations for the individual that advocate changes to these factors may be challenging to understand and improve.

It has also been recognized that the health of individuals may be impacted by various contextual factors. For example, the amount of time spent commuting that an individual undertakes, the frequency that one goes for a walk, the duration and quality of sleep, the recency of one's last vacation, and even the occurrence of current events or holidays all impact one's health to varying degrees. Often it is relatively simple for an individual to make a lifestyle change with respect to these contextual factors, such as by going on additional walks or spending less time reading about current events. The influence of these contextual factors, however, is not consistent across a population. For example, the health of some individuals is adversely impacted by temperature (hot or cold) or the stress of travel. In contrast, others may thrive under heavy travel schedules and be unphased by wide variations in temperature. Because each individual is impacted differently by these contextual factors, and because the influence of the contextual factors may be difficult to discern from the noise of regular health fluctuations, there has been very little effort to broadly utilize contextual factors to make meaningful health improvement recommendations for individuals. It would therefore be desirable to be able to identify the contextual factors that correlate with positive and negative changes in health on an individualized level, thereby facilitating individualized health recommendations to individuals.

### BRIEF DESCRIPTION OF THE DRAWINGS

FIG. 1A is a diagrammatic overview of the steps performed by a health recommendations system to generate a health vector and a health score trend for an individual, which forms part of the individual's health valence.

FIG. 1B is a diagrammatic overview of the steps performed by the health recommendations system to construct population cohorts, assign a population cohort to an individual, and identify health recommendations based on the cohort.

FIG. 2 is a diagram of a representative environment in which the health recommendations system operates to make health recommendations for an individual.

FIG. 3 is flow chart of a process implemented by the health recommendations system to construct population cohorts and assign the individual to one or more meaningful cohorts.

FIG. 4A is flow chart of a process implemented by the health recommendations system to generate health recommendations for the individual based on cohort data.

FIG. 4B is a diagrammatic representation of health score trends for different individuals, used by the system to identify cohort members similar to the individual.

FIG. 4C is a table containing contextual factors determined by the system to likely generate a positive health change for the individual.

The techniques introduced in this disclosure can be better understood by referring to the following Detailed Description in conjunction with the accompanying drawings.

### DETAILED DESCRIPTION

A health recommendations system that collects data about multiple factors pertaining to the health of an individual and uses such data to recommend contextual changes that are likely to have a positive health impact on the individual is disclosed herein. The system collects data directly characterizing the health of the individual as well as contextual data pertaining to factors that might have an impact on the health of the individual. The collected factor data is used by the system to construct a vector of the characteristics that are indicative of and reflect the individual's health over time (the “health vector”). The system may also evaluate the differences in the individual's health vector as it exists at different points in time to generate a health vector change. Using the health vector and health vector change of the individual, the system determines a current health score of the individual, which characterizes the overall health of the individual (e.g., on a spectrum from very healthy to very unhealthy) at that point in time. By periodically generating health scores based on more recent health vector information, the system also constructs a trend of the individual's health changes as the individual's health score varies over time (the “health score trend”). The system compares the individual's health score trend data with data reflecting the health score trend of similarly-situated people (i.e., one or more population cohorts), and, based on that comparison and the behavior patterns of the compared cohorts, generates recommendations for actions or changes that the individual can take that are both likely to improve the individual's health as well as likely to be adopted by the individual.

Certain data collected by the system relate to factors that directly characterize the current or past health of an individual. For example, the collected data may be objective measures of the individual's heart rate, blood pressure, blood sugar level, length of sleep, etc. Collected factors directly relating to the health of the individual may further include information regarding any chronic medical conditions of the individual (e.g., arthritis, asthma, cancer) or acute injuries of the individual (e.g., broken leg, concussion, torn ligament). Other data collected by the system relates to contextual factors that impact or characterize the health of the individual. For example, the collected data may include objective information about environmental factors around the individual, such as the weather around the individual, location of the individual, news events that may impact individual, etc. Other types of data, based on which a health vector is generated and recommendations made, may additionally be collected by the system. For example, the collected data may also include information about medically-relevant events (e.g., car accident, slips or falls, etc.). Data about the different types of factors monitored by the system, whether direct or contextual, are captured by the system over time and used to generate the health vector that characterizes the individual. As a further example, the system may also collect data related to the behavioral patterns of the individual and aspects of the individual's cognitive schema, which reflect the decision-making tendencies of the individual. The size of the health vector increases over time, as additional data characterizing the user is continuously obtained by the system. By continuously adding current information, as well as retaining historical information, the extensible health vector more accurately captures all of the factors which characterize the overall health and anticipated behavior of the user.

The health recommendations system utilizes a health assessment model to characterize the health of an individual based on the individual's health vector and health vector changes. To develop the model, a population of individuals having health vectors is manually assessed to qualitatively and quantitatively characterize the overall health of the corresponding individuals. The qualitative and quantitative characterization may be based on, for example, medical models and scientific best practices that reflect how the factors observed for an individual reflect that's individual's health. The set consisting of individual health vectors and corresponding assigned health scores is used by the system to train a health assessment model, using, for example, machine learning techniques. Once trained, the model can be applied by the system against any health vector in order to derive a health score that characterizes the individual based on the health vector.

As direct and contextual data is gathered over time by the system about a particular individual, the system periodically extends the individual's health vector. After each health vector update, the system applies the health assessment model to determine the current health score of the individual. Health vector updates and health score determinations may correspond to individual-triggered events, such as the individual's completion of a survey, achieving of a fitness goal, participation in a rewards program, etc. Updates may also be triggered by events, such as car accidents, or by medical diagnoses. The system stores the extended health vector and determined health score of the individual each time they are calculated. The stored health vector and health scores are associated with time stamps, or temporal markers, indicating the event or time with which each update is associated. The health scores and corresponding time stamps of when the health scores were assessed will be referred to herein as the individual's “health score trend.” It will be appreciated that any individual will likely have periods and discrete events in their life where their health is on the upswing, as well as periods and discrete events in their life when they experience declines in health. The health score trend reflects such changes over time for the individual. Notably, the health score trend has been found to be more reflective of the individual's overall health as compared to a characterization of the individual's health at a single point in time. As described below, the system uses the health vector and health score trend of an individual to provide the individual with health recommendations.

The health recommendations system uses the health vector of an individual to identify cohorts of similar people. On a periodic or continuous basis the system constructs population cohorts of individuals monitored by the system. The different population cohorts may be constructed, for example, based on unsupervised clustering of the individual health vectors of the population. The system may ensure that each constructed cohort includes a sufficient mix of positive and negative health scores (i.e., individuals who are both healthy and unhealthy) as well as positively and negatively trending health score trends (i.e., individuals with both improvements and declines in current health), as well as a sufficient total size. The system also generates a cohort health vector for each cohort, which represents the aggregate of the health vectors of the individuals in the cohort. Using the cohort health vectors characterizing each of the cohorts, as well as the individual's health vector, the system identifies the one or more cohorts to which the individual most closely belongs. The identification of cohorts associated with the individual occurs independently of the construction of the cohorts, and may be triggered, for example, whenever the individual's health vector is extended. It will be appreciated that the composition of the cohorts associated with an individual fluctuates over time as the individual's health vector, and the health vectors of the population, change. Because of the periodic re-assessment of the cohorts, the disclosed system is able to more accurately make recommendations to an individual since the cohorts more accurately reflect the particular characteristics, and behavioral inclinations, of the individual.

Once the cohorts associated with the individual have been identified, the system identifies particular people within the cohorts who have similar health score trends to the individual—that is, members of the cohort who have had a history of improving and declining health changes similar to the individual. To do so, the system compares the health score trends of the individual to the health score trends of the cohorts. The comparison may be performed by providing a sliding-segment comparison of health score trends. A segment encompasses multiple discrete health scores reflective of an individual's health at a point in time, over the course of hours, days, weeks, etc. The segment encompassing a recent period of the individual's health score trend may be compared against the entirety of the health score trends of cohorts members to detect other people that have matching health score trend patterns. If matching patterns are found in the cohorts, those matching members are deemed to share sufficient commonality with the individual as to warrant further analysis.

Once the similarly health-situated members within the cohorts have been identified, the system then identifies the subset of similarly health-situated members who have experienced positive health changes. For example, the system may identify the cohort members whose health score trends showed improvement following the matching segment location, which is indicative of health improvement. By identifying the cohort members with improving health following their matching segment, the system is able to focus on those within the cohort who were similarly health-situated to the individual and then experienced a desired health change. Such identified cohort members provide a dataset of similar people whose health outcomes are more likely to be relevant to the individual.

The system then identifies factors associated with positive health changes among the set of similarly health-situated cohort members. These identified factors provide the basis on which the system generates recommendations for the individual. The system may identify isolated factors associated with positive health changes, as well as multiple factors that, when simultaneously present or found in an identified sequence, are associated with positive health changes. The identified factors may be limited to the contextual factors monitored by the system. It will be appreciated that changes in contextual factors are typically more attainable by the individual than changes in direct factors. For example, an individual will have greater control over how many walks he goes on each week (i.e., a contextual factor) as compared to his blood pressure (i.e., a direct factor). However, the relationship between a contextual factor and an individual's health is typically unpredictable, unique to each individual, and difficult to discern. It is therefore a unique benefit that the system is able to accurately identify contextual factors for an individual that are associated with health improvements.

The identified factors are then filtered and ranked based on characteristics of the individual and cohorts in order to provide individualized recommendations. For example, the frequency with which a factor was identified in the cohort data (i.e., how many cohort members showed an association between the factor and positive health changes) may be evaluated. Factors found to not meet a threshold frequency are discarded by the system. The frequency associated with each factor may also be used to rank the factors, such that more frequent factors are ranked higher. As a further example, factors may be ranked according to the extent to which is the factor is associated with improved health, based on, for example the average positive slope of the corresponding health score trend, such that a factor associated with a more pronounced improvement in health is ranked higher. As a still further example, factors may be ranked according to the distance between each factor and the state of the individual for whom the recommendation is being made. That is, if identified cohort members showed equivalent positive outcomes for meditating 30 minutes a day and going on four walks a week, and the individual already meditates 20 minutes a day but goes on no walks, then the system may prioritize the recommendation to go on four walks a week. As an additional example, factors can be ranked according to the likelihood that the individual will actually adopt or act upon the recommended factor. The likelihood of adoption can be based on historical engagement or adoption data among the population as a whole or among the corresponding cohorts to the individual. Rankings can be non-trivial, involve probabilistic models, and have stochastic elements, and are used to determine the most efficacious recommendations that the individual's health vector indicate they are likely to adopt. The filtered and ranked factors are then provided by the system to the individual as a health recommendation.

The system can provide, on an on-going basis, recommended changes to contextual factors that are likely to cause an improvement in the health of the individual. To do so, the system continues to monitor the various direct and contextual factors associated with the individual. Recently captured factors are used to extend the health vector associated with the individual. Based on the extensible health vector, the system assesses the health of the individual and refreshes the health score trend of the individual. In a similar fashion, the health vectors and health score trends of other population members are continually being refreshed. The refreshed data may reflect, for example, the outcomes of recommendations provided by the system. The refreshed health vectors and health score trends of the individual and the population can then be used to generate further recommendations for the individual. In doing so, the system is able to continuously generate new recommendations and new types of recommendations based on outcome-driven population data.

On a periodic basis, the system may update the health assessment model based on additional data characterizing the health changes of individuals within the population. For example, the system may receive updated indications of overall health of monitored individuals (e.g., by medical professionals), which may be used to refine how the health assessment model determines whether an individual is health or unhealthy based on a health vector and health vector changes.

Various implementations of the system will now be described. The following description provides specific details for a thorough understanding and an enabling description of these implementations. One skilled in the art will understand, however, that the system may be practiced without many of these details or with alternative approaches. Additionally, some well-known structures or functions may not be shown or described in detail so as to avoid unnecessarily obscuring the relevant description of the various implementations. The terminology used in the description presented below is intended to be interpreted in its broadest reasonable manner, even though it is being used in conjunction with a detailed description of certain specific implementations of the system.

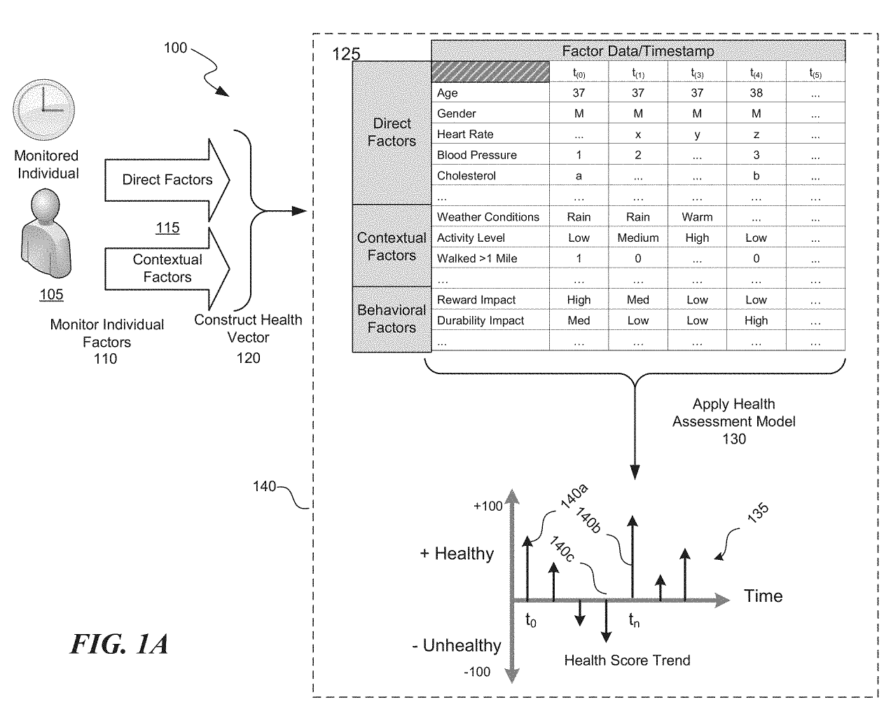

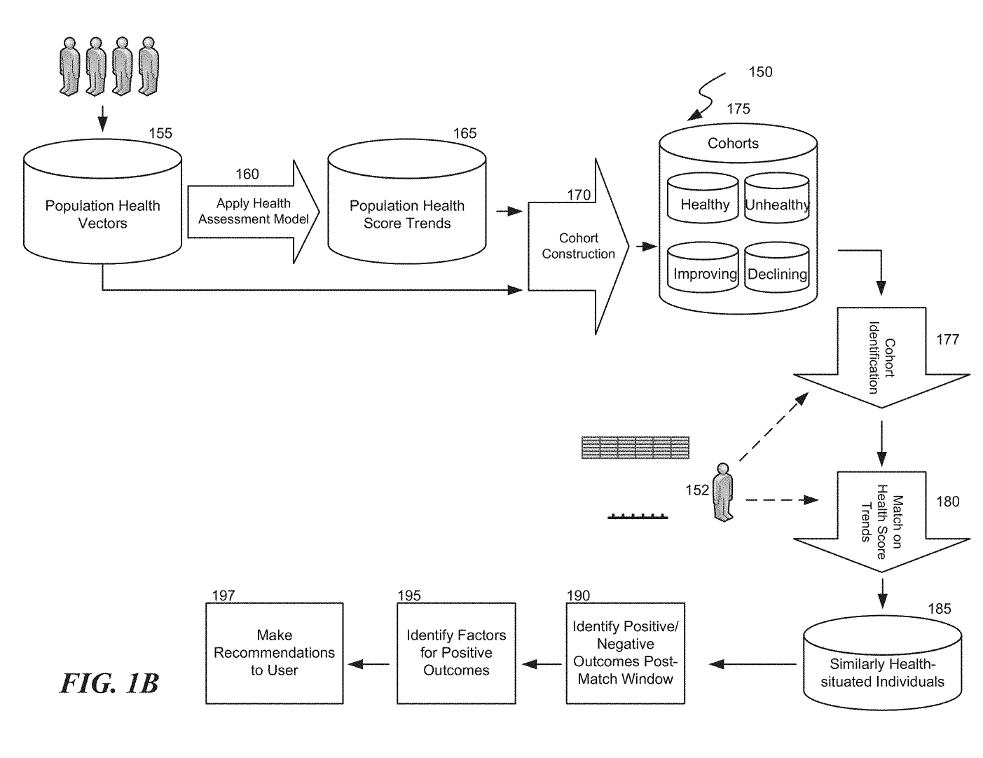

FIGS. 1A and 1B and the following discussion provide a brief, general description of a diagrammatic overview of steps performed by a system for providing health recommendations based on extensible health vectors. As described herein, FIG. 1A illustrates the steps performed by the system to construct a health vector and a health score trend for an individual, which combined represent part of the health valence of the individual. FIG. 1B illustrates the steps performed by the system to construct, based on a generated health vector and health score trends, population cohorts; to identify the population cohorts with characteristics similar to an individual; and to identify health recommendations for the individual based on the identified cohorts.

FIG. 1A illustrates a process 100 performed by a health recommendations system for constructing a health vector 125 and a health score trend 135 associated with an individual 105. The individual 105 may be monitored 110 on a periodic or continuous basis. Monitored data of the individual includes direct factors and contextual factors 115 pertaining to the health of the individual. Direct factors directly characterize the health of the individual, and may include objective measures such as the individual's heart rate, blood pressure, age, weight, cholesterol level, length of sleep, medical conditions, acute injuries, etc. Contextual factors relate to other factors that impact or characterize the health of the individual, such as the weather at the individual's location, the amount of recreational travel done by the individual, the frequency of social activities undertaken by the user, etc. Monitored data of the individual may include other types of data, such as, for example, behavioral patterns.

The data about an individual may be gathered by the system using a variety of techniques. Monitoring may be achieved, for example, using sensors connected to or adjacent to the individual. For example, the individual may wear a fitness band or smart watch which gathers information about the heart rate of an individual. As another example, the individual may carry a smartphone which monitors movement of the individual. From the movement information, the smartphone is able to estimate the number of steps that an individual takes during a particular period. By monitoring sensor data associated with the individual, the system is able to obtain information about the current physical condition of the individual. Other data may be gathered by the system by accessing various data sources. One example of a data source containing information relevant to an individual's health state is the stored health information about an individual. With authorization, the system may access an individual's stored medical information in order to identify certain medical conditions afflicting the individual. Another example of a data source that can be consulted by the system is a weather service. Using a known location of an individual, the system may use an application programming interface (API) to access a service and receive information about the current or anticipated weather at the location of the individual. A further example of a data source that can be consulted by the system is the online activities of the individual. For example, the individual may grant the system access to the individual's social networks, e-mail accounts, browsing activities, etc. By accessing the individual's online activities, the system may be able to monitor, for example, the frequency of the individual's social network activity, the recipients of e-mail messages sent by the individual, and the topics of web sites visited by the individual. Finally, the system may gather information about the individual through questions or surveys that are presented either directly to the individual or to others that know the individual. The questions or surveys can be used by the system to directly solicit information which may relate to the current health state of the individual.

Direct and contextual factors 115 are constructed 120 by the system into a health vector 125 that characterizes the individual over time. As illustrated, the health vector 125 may be represented by a table in which each row represents a different monitored factor and each column represents the value for that factor at a particular time. Every time the value of a factor is detected or occurrence of the factor is recorded, a time stamp may be associated with the factor so a temporal component is maintained by the health vector. As factors are monitored over time, additional data is added to each row—thereby “extending” the health vector across all factors. It will be appreciated that not all factors are measured at each time, meaning that certain factor data will be missing in the table. As a result, certain factors may have a significant amount of associated data, while other factors have very little associated data. Factors as characterized by the health vector 125 may have quantitative values (e.g., age and weight) or qualitative value (e.g., weather conditions and activity level). Moreover, in some embodiments, the health vector 125 may include one or more continuous series represented by, for example, a curve, where the curve reflects the value of a factor over time. Factors may be monitored by the system at regular or irregular intervals. Certain factors may change at a predictable rate (e.g., age), certain factors may remain fixed (e.g., gender), and certain factors may vary unpredictably (e.g., weight). The system is therefore flexible by allowing different factors to be monitored at different rates and at different times.

Some factors are monitored on a regular basis and values stored by the system in the health vector. As is often the case, however, monitoring windows might be missed, data may become lost or corrupted, and gaps may therefore form in the health vector record. When identifiable gaps in the health vector occur, the system may predict the value for a missing factor by extrapolating between known prior values for the individual or projecting forward based on past data.

In addition to direct and contextual factors, the health vector 125 may include other categories of data. For example, as illustrated in FIG. 1A, the health vector 125 may include behavioral factors. The behavioral factors may include a measure of the “reward impact,” which characterizes the extent to which the individual is motivated by a rewards program. As a further example, the behavioral factors may include a “durability impact,” which characterizes the persistence of behaviors newly learned by the individual. It will be appreciated that other behavioral factors, which provide insights into the behavioral patterns and aspects of the cognitive schema of the individual, may be monitored by the system.

Though not illustrated, the health vector 125 may include other categories of data. For example, the health vector 125 may include indications related to different events, such as current events, health events, injury events, etc. That is, an individual's health vector may include an indication of the occurrence of a significant injury (e.g., a car accident) or event (e.g., divorce) and the associated temporal marker indicating when the event occurred.

As a further example, the health vector 125 may include contextual health scores. In contrast to the health score generated by the system, which characterizes an individual's overall health, the contextual health scores reflect an assessment of the individual's health or wellness within a narrower context. For example, a CDC score may reflect an assessment by the Center of Disease Control of the likelihood of the individual getting sick. As an additional example, an eating score may indicate how healthy an individual's diet is. As a further example, an intervention score may indicate an individual's susceptibility to, or need for, a positive health intervention. Contextual health scores may be received by the system from, for example, third-party services or health accounts associated with monitored individuals 105.

It will be appreciated that the table in FIG. 1 is merely one form in which a health vector might be represented. The health vector could be represented in flat files, linked lists, or other data constructs that allow for convenience in processing. One skilled in the art will understand the various computational benefits associated with the different implementations. Furthermore, though described here as differently categorized, it will be appreciated that the additional data types (e.g., contextual health score, injury events, etc.) may also be categorized in the health vector 125 as part of direct factors, contextual factors, behavioral factors, etc.

On a continuous or periodic basis, a health assessment model is applied 130 by the system to the health vector 125 to generate a current health score 140 of the individual, which represents whether the individual's overall health at a point in time. Over time, the system stores each assessed health score 140 to construct a health score trend 135 for the individual. The health score trend 135 is therefore made up of a time series of health score 140, each of which correspond to an evaluation of the health vector 125 using the health assessment model, and which in combination indicate the trend (i.e., improving or declining) of the individual's health.

The health assessment model generates an indication of an individual's level of healthiness or unhealthiness (e.g., on a spectrum from very healthy to very unhealthy) based on one or more of the individual's health vector, the individual's health vector change and the health vectors of the members in the cohorts associated with the individual. The model reflects the understanding that health vectors, which capture both current and historical health factor data of individuals, characterize the bases on which an individual's health may be assessed. That is, the health assessment model recognizes that certain combinations of factors reflected in the health vector (e.g., overweight, high blood pressure, lack of sleep, lack of physical activity, etc.) are strongly indicative of poor health, while other factors reflected in the health vector (appropriate weight, acceptable blood pressure, low cholesterol, regular physical activity, etc.) are strongly indicative of good health. The health assessment model may assess both historical data stored in the individual's health vector (e.g., the history of changes to the individual's blood pressure), the current data stored in the health vector (i.e., the individual's current blood pressure), and health vector changes (e.g., differences in the individual's blood pressure captured at different times) to generate a health score. The health score of an individual may be represented by a value, such as from +100 to −100, that corresponds to strongly healthy and strongly unhealthy, respectively. The system generates the health assessment model using machine learning techniques. The system relies upon a training dataset made up of health vectors and corresponding health scores for known population members. The provided health assessment may have been performed manually, for example by medical professionals, who have assessed the health of each population member based on the totality of the information contained in each member's health vector. The training dataset is used by the system to train the health assessment model to automatically evaluate new health vectors that are analyzed using the model. Over time the system may re-train the health assessment model based on observed population data. For example, the observed population health vectors may include subsequent health assessments performed by medical professionals or provided by the associated population members (e.g., a self-assessment provided by a member). When a sufficient threshold of new health vectors/health scores is detected, the system re-trains the model to help identify new correlations between health vectors and health scores.

By applying the health assessment model to the health vector 125 on a periodic basis, the system determines the changes in health of the individual based on the periodically generated health scores. For example, the system may apply the health assessment model on a weekly basis to the health vector 125 to assess the individual's change in health. As another example, the system may apply the health assessment model to the health vector each time that the health vector is extended. The system stores the assessed health score 140 of the individual as a time series, or health score trend 135, with each health change assessment associated with a time stamp reflecting when the assessment was performed. For example, the health score 140a is illustrated as having time stamp t₀, meaning that the health score was determined at time t₀ from the then-current health vector for the individual. As a further example, the health score 140b is illustrated as having time stamp tₙ, and reflects the health score generated from a health vector as it existed at time tₙ. In other words, as factors are monitored and the health vector 125 extended, the system updates the health score trend 135 with new health score 140 added to the time series. Each health score 140 in the health score trend characterizes the health of the individual using a scale that ranges from healthy to unhealthy. For example, the depicted health score trend 135 illustrates a health score characterization between −100 and +100, where positive numbers reflect different degrees of good health and negative numbers reflect different degrees of poor health. That is, the health score trend 135 shows a medium level of health at health score 140a, followed by change to poor health at health score 140c, then a spike to strong health at health score 140b. It will be appreciated that the health score trend 135 captures changes in an individual's health over time, thereby representing the trending changes in an individual's health. As will be described in additional detail herein, health score trends 135 are used by the system both to identify similarly health-situated individuals (i.e., individuals with similar patterns of improving and declining health) as well as to identify individuals with positive health improvements that can be used for purposes of generating recommendations.

The system may also construct a health valence 140 for the individual. The health valence 140, which may include the health vector 125, health vector changes, and health score trend 135 of an individual, provides an alternative representation of the state of the individual's health over time. The system may maintain the health valence 140 to, for example, facilitate the analysis of and comparison between different monitored individuals 105.

FIG. 1B illustrates steps 150 performed by a health recommendations system to make recommendations to improve the health of an individual 152. The individual 152 is a member of a population of individuals monitored by the system, each of whom has an associated health vector stored in a population health vectors dataset 155. Each health vector of the population health vectors dataset 155 may be generated, for example, by the steps described with reference to FIG. 1A. As additionally described with reference to FIG. 1A, a health assessment model is applied 160 on a periodic or continuous basis to the population health vectors dataset 155 to generate a population health score trends dataset 165. The health score trends dataset 165 contains a record of the health scores compiled over time for each member of the population.

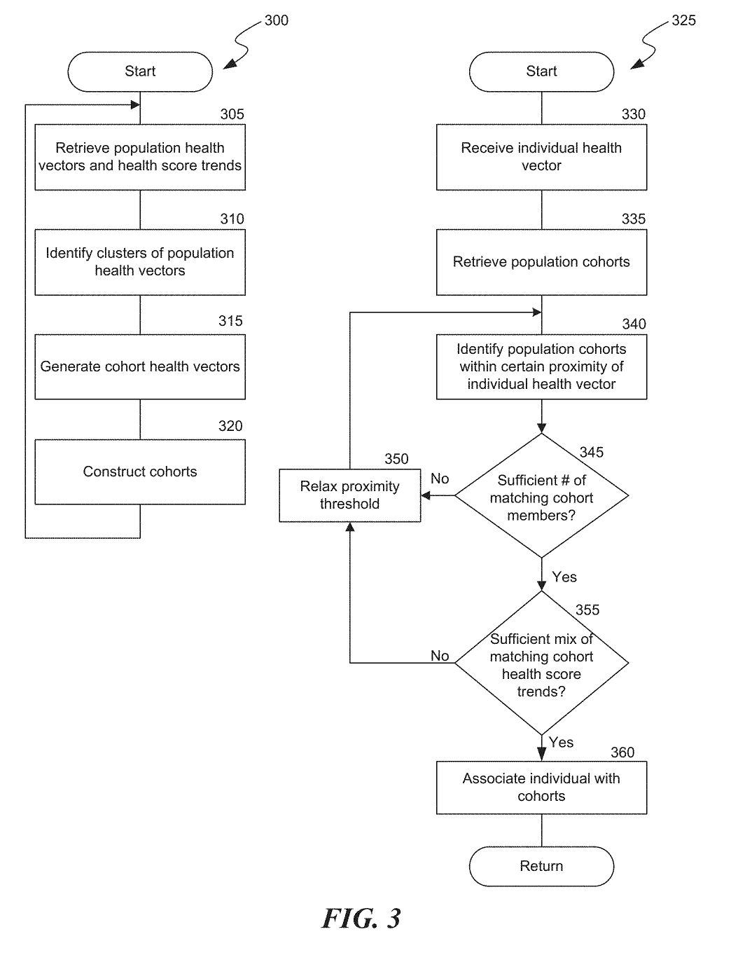

In order to generate recommendations for the individual, the system identifies sets of people from the population that are similar to the individual (i.e., the system identifies “cohorts” associated with the individual). As described herein, the system constructs population cohorts periodically, and separately identifies the cohorts most closely associated with the individual when the individual's health vector is extended. That is, cohort construction for a population and cohort identification for an individual are triggered independently. The process for constructing population cohorts and identifying the cohorts that are correlated with an individual is described in greater detail herein with reference to FIG. 3.

The system constructs 170 a cohort dataset 175 based on the population health vectors 155 and population health score trends 165. The cohort dataset may be constructed, for example, by performing unsupervised clustering of the population health vectors 155 to identify health vectors in close proximity to one another (i.e., the distance between vectors is minimized). It will be appreciated that other techniques for clustering a set of health vectors may be used. Notably, the cohort dataset 175 is constructed such that it is of sufficient size for analysis purposes and also so that it includes sufficient variety. For example, a cohort may be constructed such that it includes both individuals experiencing health improvements and individuals experiencing health declines, as determined by the corresponding health state trends. As a further example, a cohort may be constructed such that it includes both healthy and unhealthy individuals, as determined based on the most recent health scores for the individuals. Cohorts may include, for example, between 10 and 1,000 individuals. Though cohort constructions has been described as utilizing unsupervised clustering, cohorts may also be generated based on expressed characteristics. For example, using specific weightings associated with different characteristics, the system may construct a cohort of individuals experiencing health improvement and another cohort of individuals experiencing health decline. As a further example, the system may construct cohorts encompassing different magnitudes and suddenness in health changes, such as a cohort of individuals with rapidly declining health and a cohort of individuals experiencing a sudden improvement in health. Cohorts may be constructed, either expressly or unsupervised, that comprehend additional features common across the population.

Once the cohort dataset 175 has been constructed, the system identifies 177 the cohorts most similar to the individual. Cohort identification may occur any time after cohorts have been constructed, such as when the individual's health vector is being extended. That is, the system may continuously or periodically construct population health vectors based on updated population data, and then identify the clusters associated with the individual upon a triggering event. Each of the constructed cohorts have a corresponding cohort health vector, which reflects the health vectors, in aggregate, of the members of the cohort. The system performs a vector comparison of the individual's health vector and the cohort health vectors and identifies the cohorts for which the comparison yields a sufficiently small distance. The cohort health vector may be based on, for example, the average of member health vectors, a statistical distribution of member health vectors, or a density of member health vector values. It will be appreciated that other ways may be used to define a cohort health vector that reflects the health vectors of members of a clustered cohort. In some embodiments the cohort health vector depends on the way in which the populations were clustered.

Once similar cohorts have been identified, the system matches 180 the health score trend of the individual 152 to the health score trends of the individual's cohorts to identify members of the cohorts who are similarly health-situated to the individual. Similarly health-situated means that the members and the individual share a health score trend pattern that, at least for a period of time, is similar to one another. As described herein, similarly health-situated individuals may be identified by comparing a segment (referred to as the analyzed “window”) covering a recent period of time of the health score trend of the individual 152 to similar-sized segments of the health score trends of the cohorts. That is, a cohort member may be identified as similarly health-situated if any segment of data in the cohort member's health score trend matches the most recent segment of data from the individual's health score trend. In performing this analysis, the system may limit the evaluation of cohort members' health score trends to only those segments of time of a certain recency, or may extend the analysis for the entire period of the health score trend. The system stores the identity of similarly-situated individuals in dataset 185.

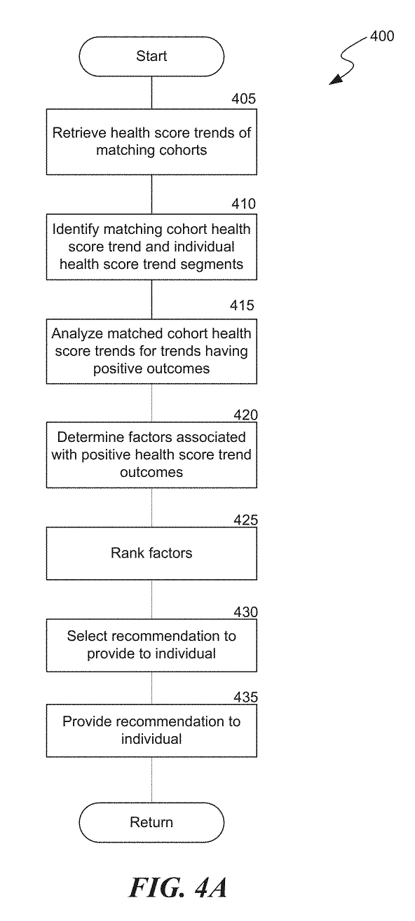

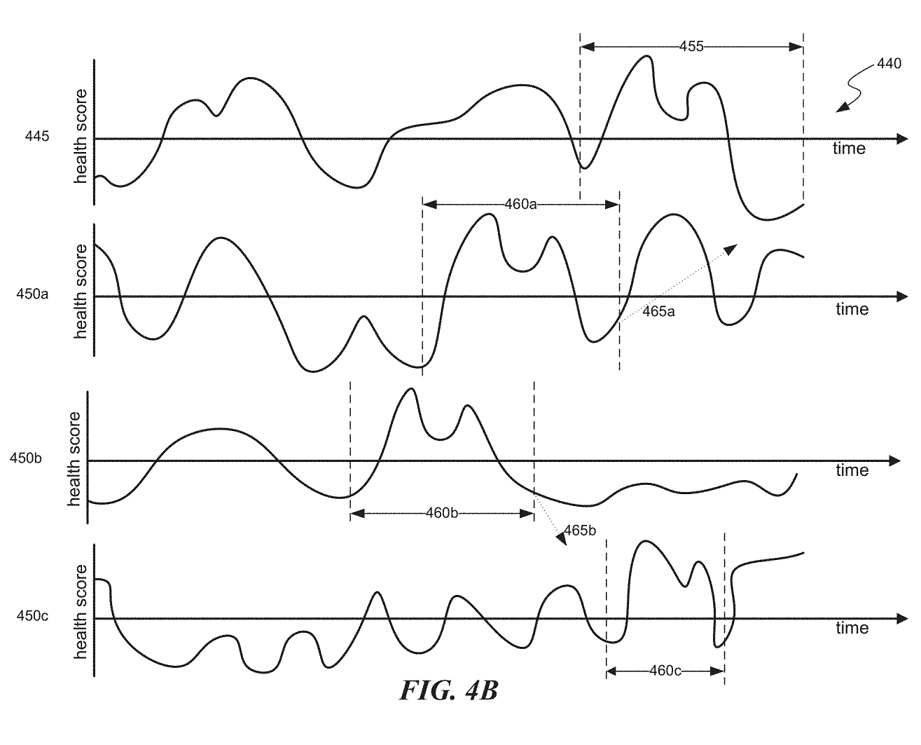

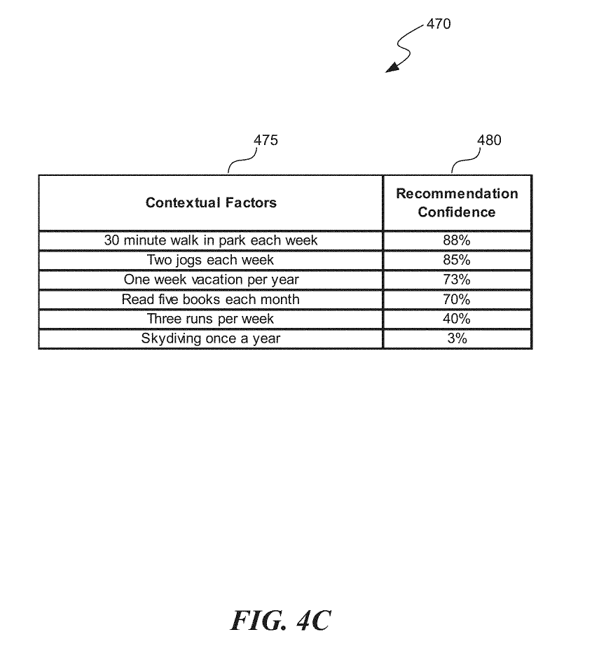

Once the system has identified cohort members having a similar health score trend to the individual 152, the system identifies 190 which of the similarly health-situated individuals subsequently had positive or negative changes to their health. That is, the system attempts to find cohort members that, following the health score trend segment that matched the individual, subsequently continued on in life with a period of increasing health. Increasing health may, for example, be detected based on subsequent positive health scores. The sliding window analysis to identify similarly health-situated cohort members, as well as those cohort members that went on to periods of more robust health, is described in greater detail herein with reference to FIG. 4B.

After identifying cohort members that went on to periods of better health, the system identifies 195 the factors associated with positive health changes in the set of similarly health-situated individuals 185. The system may identify individual factors associated with positive health changes, as well as multiple factors that when present in combination are associated with positive health changes. To identify the positive factors, the system analyzes the health vectors of the set of individuals identified at step 190 to determine which factors were present or changing at approximately the time that the corresponding health score trends showed improvement. In addition to identifying factors correlated with positive health changes, the system also determines the strength of correlation or amount of influence that each factor had on the corresponding health change. The analysis may be limited to improvements just following the matching segment for each cohort member, thereby identifying those factors associated with improvement for similar individuals when they were in a health state comparable to the individual's health state. Such analysis can be performed using an evaluative algorithm that identifies the existence of one or more factors across multiple cohort members having a positive correlation with health.

Finally, the system makes recommendations 197 to the individual based on the identified factors 195. As described herein, the system may rank the identified factors 195 based on, for example, the strength of correlation, the positive slope of health score trends, the distance between the recommended factor and the individual's present value for that factor, the history of adoption among the cohort members, etc.

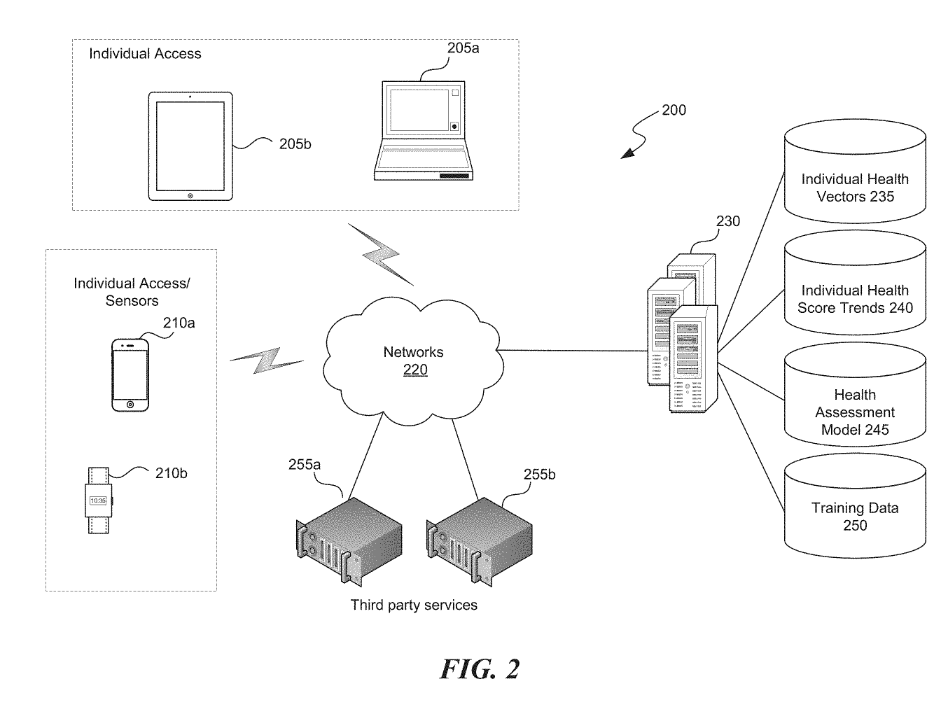

FIG. 2 and the following discussion provide a brief, general description of a suitable environment in which a system to provide individualized health recommendations based on extensible health vectors may be implemented. Although not required, aspects of the system are described in the general context of computer-executable instructions, such as routines executed by a general-purpose computer, a personal computer, a server, or other computing system. The system can also be embodied in a special purpose computer or data processor that is specifically programmed, configured, or constructed to perform one or more of the computer-executable instructions explained in detail herein. Indeed, the term “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the system can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions reside on a client computer.

FIG. 2 illustrates an example environment 200 in which a health recommendations system operates. The environment may include one or more client computing devices 205, health sensors 210, server computers 230, and third party services 255. Health sensors 210 may be used to monitor health factors of an individual, and are typically on or adjacent to the monitored individual. For example, sensor 210a illustrates a smartphone which may be used to monitor the location and movement of the individual. As a further example, sensor 210b illustrates a smart watch which may be used to monitor the heart rate and other biometric data of the individual. The client computing devices 205 and sensors 210 communicate with each other and the server computers 230 and third party services 255 through networks 220 including, for example, the Internet. The client computing devices 205 and sensors 210 may communicate wirelessly with a base station or access point using a wireless mobile telephone standard, such as the Global System for Mobile Communication (GMS), or another wireless standard, such as 802.11 or Bluetooth, and the base station or access point communications with server computers 230 and third party services 255 via the network 220.

Aspects of the health recommendations system may be practiced by the client computing devices 205, health sensors 210, server computers 230, and third party services 255. For example, direct factors characterizing the health of an individual may be received by the server computers 230 from a client computing device 205 and a sensor 210 associated the individual, as well as third party services 255. That is, the server computers 230 may receive an individual's heart rate from sensor 210b and an individual's response to a survey directed to mental well-being from client computing device 205. The server computers 230 may also receive social media content authored by the individual from third party services 255. As a further example, contextual factors characterizing the health of the individual may be received by the server computers 230 from client computing devices 205, sensors 210, and third party services 255. Contextual factors may include data from individuals other than the individual. For example, the servers 230 may receive survey responses, provided by a spouse of the individual and pertaining to the mental state of the individual, from a client computing device 205 associated with the spouse. The server computers 230 may also receive environmental data from third party services 255, such as the weather and temperature at the individual's current location. Direct and contextual factor data may be received by the server computers 230 on a periodic basis (e.g., hourly, daily, weekly, etc.), based on which the server computers 230 may generate extensible health vectors for monitored individuals. The health vectors may be stored in individual health vector storage area 235.

On a periodic or ongoing basis, the server computers 230 calculate and maintain a health score trend for the individual based on the stored health vector. An individual's health score may be determined by a health assessment model, maintained by the system in health assessment model storage area 245, that characterizes whether an individual is healthy or unhealthy based on an evaluation of the individual's health vector. The health assessment model may additionally evaluate the health vectors of cohorts associated with the individual. The health assessment model may have been initially formed by training data stored in training data storage area 250. The time series of health score for the individual, which forms the health score trend for the individual, may be stored in health score trend storage area 240.

### Associating an Individual with Applicable Cohorts

FIG. 3 is a flow diagram illustrating example processes 300 and 325, implemented by a health recommendations system, for constructing cohorts based on population data and for associating an individual with one or more constructed cohorts, respectively.

The process 300 begins at a block 305, where the system retrieves the health vectors and health score trends of the monitored population. As described herein, a health score trend, comprised of a time-series of health scores, captures the extent to which an individual's health is changing over time. The system monitors a population of individuals and generates health vectors for each of the individuals on a continuous or periodic basis. The system additionally generates health score trends for each of the individuals in the population, based on the evaluation of the individuals' health vectors with a health assessment model, on a continuous or periodic basis. The retrieved population health vectors and health score trends may be maintained in individual health vectors storage area 235 and individual health score trend storage area 240, respectively.

At a block 310, the system identifies clusters of monitored individuals based on the retrieved individual health vectors. The identification of clusters, or clustering, groups health vectors in such a way that health vectors in the same cluster are more similar to each other than those in other clusters. For example, the system may identify a cluster comprised of individuals who were in a car accident in the past 18 months and now experience back pain, and another cluster comprised of individuals who run three times a week and have high cholesterol levels. It will be appreciated that the system may use a variety of unsupervised algorithms, based on different models of clustering, to identify clusters of population health vectors. For example, the system may utilize centroid models, such as a k-means algorithm, that represents each cluster with a single mean vector. The system may use distribution models in which clusters are modeled using statistical distribution. And the system may use density models, such as the DBSCAN algorithm, which define clusters as connected dense regions in the data space. In other words, the clusters are defined by the population health vectors and the cluster model parameters. As such, it is difficult to predict with any accuracy which factors will result in generated clusters. Instead, the system provides unique insights into the data that was previously unavailable using traditional methods of clustering with demographic information.

At a block 315, the system generates cohort health vectors characterizing each of the identified clusters. The cohort health vectors represent the health vectors, in aggregate, of the members of each of the clusters. The generation of the cohort health vectors may be based on the modeling method used to identify the corresponding clusters. For example, if clusters were identified using a centroid model then the corresponding cohort health vector may be based on the average of health vectors for the members of the cluster. It will be appreciated that other ways of characterizing a cluster, comprised of member health vectors, with a representative single health vector may be used.

At a block 320, the system constructs cohorts from each of the identified population clusters. Each constructed cohort may include, for example, the health vectors and health score trends of the members of the corresponding cluster, as well as the associated cohort health vector generated by the system. Process 300 then returns to block 305 to retrieve additional population health vectors and health score trends, thereby constructing new cohorts as updated population data is obtained by the system.

Process 325 is performed by the system to associate an individual with one or more population cohorts, such as cohorts constructed by the process 300. The process 325 begins at a block 330, where the system receives an updated health vector for an individual. As described herein, the health vector characterizes various factors, pertaining to health, associated with the individual over time. The health vector is “extended” as it is updated to encompass more recent data for the various factors. The retrieval of the individual's health vector may be triggered by various conditions. For example, the health vector may be retrieved when the system determines that new factor data has been received and the health vector has therefore been recently extended. As another example, the system may determine that the occurrence of an event (e.g., a breaking news item, the completion of a health program by the individual, a medical event, an injury, etc.) has triggered the need for new recommendations for the user. As an additional example, the system may determine that cohorts need to be newly associated the individual, such as when the individual is new to the system and no cohorts have been associated, or when a previously-associated cohort for the individual has sufficiently aged such that the data it contains is now considered stale. As yet another example, the system may periodically associate cohorts for an individual, in order to ensure that the cohorts associated with the individual will always contain the most recent set of population members that might be relevant to the individual.

At a block 335, the system retrieves population cohorts. The population cohorts may have been constructed, for example, by the process 300. Each cohort is characterized by a cohort health vector and includes health vectors and health score trends of the population members of the cohort.

At a block 340, the system identifies the cohorts for which the associated cohort health vectors are within a certain proximity to the received individual health vector. Such a comparison may be made, for example, by calculating a sum total of the squares of the distance or difference between each of the factors making up the health vector. In making such calculation, each of the factor ranges may be normalized to a scale that allows a comparison between factors. For example, the following equation can be used to calculate the distance, where I (f₁,f₂,f₃, . . . , fₙ) represents the individual health vector made up of factors f₁, f₂, etc., and C (f₁,f₂,f₃, . . . , fₙ) represents a cohort health vector made up of factors f₁, f₂, etc.:

Distance=Σ|(f₁,f₂,f₃, . . . , fₙ)−C(f₁,f₂,f₃, . . . , fₙ)|

The proximity check may be made using all factors represented by the health vector, or it may be based on select factors contained in the health vector. For example, the proximity calculation might be based on only the direct factor data that is contained in a health vector and not take into account the contextual factor data. For the evaluated factors, the proximity check determines whether the aggregate distance between each of the cohort health vectors and the individual health vector falls within a threshold distance. The system may identify a cohort health vector as satisfying the proximity check when all of its evaluated factors, when summed, are within a threshold distance from the evaluated factors of the individual health vector. Alternatively, the system may identify a cohort health vector as satisfying the proximity check when a certain percentage of the factors being compared fall within a threshold distance of each other. The extent to which each of the evaluated factors in a health vector influences the proximity check may be weighted differently. For example, the system may identify that a confluence of factors present in an individual's health vector makes that individual more susceptible to a particular medical condition; accordingly, the may more strongly weight factors relevant to that medical condition. As a further example, the system may identify that certain factors vary widely across the monitored population but have little impact on health, and therefore accord those factors a low weight. It will be appreciated by one skilled in the art that other techniques may be used to compare distance between the health vectors and assess overall proximity.

At a decision block 345, the system determines whether the population cohorts identified at block 315 include a sufficient number of cohort members. For example, the system may be configured to require than an individual be associated with cohorts containing at least 1,000 individuals collectively, and accordingly, determine whether at least 1,000 cohort members were included in the cohorts identified as matching at block 315. If it is determined that a sufficient number of cohort members were identified, then processing continues to a decision block 355. If it is determined that an insufficient cohort members were identified, then processing continues to a block 350.

At the decision block 355, the system determines whether a sufficient mix of individuals have been identified at block 340. As described herein, every population cohort includes the health score trends of the cohort members. The system may evaluate the health score trends corresponding to the population cohorts identified at block 340 and determine whether those health score trends represent a sufficient mix of individuals with improving health and declining health. The determination of whether a health score trend shows that health is improving or declining may be based, for example, the changes between the most recent health scores included in the health score trend. As a further example, the system may evaluate the health score trends corresponding to the population cohorts identified at block 340 and determine whether those health score trends represent a sufficient mix of healthy and unhealthy individuals. The determination of whether a health score trend corresponds with a healthy or unhealthy individual may be based, for example, on the value of the most recent health score in the health score trend, or alternatively on the net value of the health scores over the entirety or subset of the health score trend. Ideally, a sufficient mix would dictate a 50/50 ratio between improving and declining individuals or between healthy and unhealthy individuals. Depending on the cohort data, however, the system may operate with a different ratio such as 60/40, if a 50/50 ratio cannot be achieved.

As an alternative or in addition to evaluating whether the health score trends correspond with enough individuals with improving and declining health, or with enough healthy and unhealthy individuals, the determination of whether there is a sufficient mix may also be based on the distribution of net values of the health scores over the entirety or subset of the health score trends (i.e., whether there is an adequate distribution of health score trends with net values ranging, for example, from −100 to 100). It will be appreciated that other evaluative techniques may be employed to determine whether the health score trends capture a sufficient mix of individuals. If it is determined than an insufficient mix of health score trends have been identified, then processing continues to the block 350. If it is determined that a sufficient mix of health score trends have been identified, then processing continues to a block 360.

At block 360, the system associates the individual with the population cohorts identified at block 340. The cohort members are those individuals from the population that have been identified as similar, based on comparisons of health vectors, to the individual. After associating the cohorts with the individual, the process 325 returns.

If it was determined that an insufficient number of cohort members or an insufficient mix of health score trends were identified at the decision blocks 345 or 355, respectively, then at block 350 the system relaxes the proximity threshold used to identify matching population cohorts. Relaxing the proximity threshold may comprise allowing for a greater distance between values of the individual and cohort health vectors. Relaxing the proximity threshold may also comprise, for example, evaluating a shortened segment (e.g., only the most recent data) of the health vectors. And relaxing the proximity threshold may comprise allowing for the proximity check being satisfied by a smaller percentage of evaluated factors satisfying the distance check. It will be appreciated that other techniques may be used to relax a proximity check performed between an individual health vector and the generated cohort vectors, thereby identifying a larger set of matching cohorts among the set of constructed cohorts. The process then returns to block 340, where cohort health vectors are again assessed using the relaxed proximity thresholds.

### Providing Recommendations to an Individual

FIG. 4A is a flow diagram illustrating an example process 400, implemented by a health recommendations system, for generating health recommendations for an individual based on cohort data. At a block 405, the system retrieves health score trends for the cohorts associated with the individual. The associated cohorts may have been identified, for example, based on the process 325 described above.

At a block 410, the system identifies cohort health score trends that have segments matching a segment of the health score trend of the individual. For example, the system may compare the most recent segment of the individual's health score trend to the entirety of the health score trends of the cohorts associated with the individual in order to find matching segments in the cohorts. Segments are comprised of multiple health score associated with time stamps that make up a health score trend. A visualization of how matching segments of health score trends are identified is illustrated in FIG. 4B, described below.

FIG. 4B is a diagrammatic representation 440 of health score trends for an individual under analysis and members of cohorts associated with that individual. For example, health score trend 445 may represent the health score trend for an individual, and health score trends 450a, 450b, and 450c may represent the health score trends for members of associated cohorts. As illustrated, each health score trend is represented by a curve of health scores over time. That is, the health score trend captures both the health scores of the represented individual at different points in time, as well as the change or trend in health scores over time. The curve may be fitted by the system to the discrete assessments of health scores that is performed by the system, such as is depicted in FIG. 1A. The curve above the time-axis represents a positive state of health, while the curve below the time-axis represents a negative state of health.

As described, the matching of health score trends may be based on segments of health score data. One or more segments of the individual health score trend may be used to identify matching health score trends in the cohort data. For example, segment 455 of individual health score trend 445 represents the most recent health scores of the individual. As illustrated in FIG. 4B, only segment 455 is used as the basis of health score trend matching. However multiple segments of the individual health score trend 445 may be used for matching, such that a cohort health score trend is identified as matching if it contains segments that match a sufficient number of the individual health score trend segments.

The system evaluates segments of cohort health score trends 450a, 450b, and 450c to identify any segments that match the individual health score trend segment 455. To identify matching segments, the system performs a sliding window analysis, conceptually overlaying the segment 455 on the trend curve being analyzed and calculating a difference between the segment 455 and a corresponding portion of the trend curve under comparison. As the segment 455 is compared to the entirety of the trend curve under analysis, matching segments of the trend curve will be detected when the difference between the two segments (i.e., segment 455 and the corresponding segment of the trend curve under analysis) falls below a threshold. Such an analysis ensures that older health scores of the cohort members may generate a match on the individual. For example, cohort segments 460a and 460b were each identified as matching segment 455, though at different ages relative to the most recent data of their respective cohort health score trends. Cohort segment 460c, although close, may be found by the system to not match segment 455. It will be appreciated that any cohort will likely include members with health score trends with matching segments and health score trends in which no segments match the individual health score trend segment. Cohort health score trends with no matching segments, or an insufficient number of matching segments, would not be identified by the block 410 of FIG. 4A. As described herein, the matching health score trend segments enable the system to identify which factors lead to improving and declining health, as well as overall positive health, for the individual.

Returning to FIG. 4A, at a block 415 the system analyzes the matching cohort health scores trends to identify which have positive health outcomes. For example, the system may evaluate how the health scores of the cohort health score trends changed following the health score trend segments that matched and identify positive trends (indicative of improving health) or positive health scores (indicating of a healthy individual). By evaluating changes to cohort health scores immediately or closely following the matching segments, the system is able to identify positive outcomes from periods that are often more relevant to the analyzed health score trend of the individual (for example, when the individual health score trend segment used for matching was the most recent health score data for the individual).

Referring again to FIG. 4B, health outcomes 465a and 465b illustrate the result of the analysis performed by the system at block 415 of FIG. 4A. Each health outcome 465a and 465b reflects the system's characterization of the health changes of the represented cohort member following the matching segment 460a and 460b, respectively. The outcomes 465 may include a direction (representing an increase or decrease in health) as well as a slope (representing the magnitude in change of health). For example, health outcome 465a represents a modest improvement in health and health outcome 465b represents a modest decline in health. The health outcomes 465 may be determined, for example, by evaluating the health scores and health score trend for a period following the relevant segments. That is, health outcome 465a shows a modest health improvement because the health score following segment 460a improved significantly, and declined to its original level of healthiness, before showing less significant health improvement. Health outcome 465b shows only a modest health decline, even though the health score demonstrated health decline for the entire period following segment 460b, because the health scores never reflected too significant a decline in health. That is, health outcomes 465 are determined based on both the net values of health scores relative to the start of the period of analysis (i.e., just after a segment 460) as well as how consistently health scores showed health improvement. Using the example illustrated in FIG. 4B, the analysis of block 415 in FIG. 4A would identify cohort health score trends 450a as having positive health outcomes.

Returning again to FIG. 4A, at a block 420 the system determines the factors associated with the identified positive health outcomes. The system may time-align the health vectors and health score trends for all cohort member identified at block 415, and based on an analysis across all the identified cohort members, identify which factors in the health vectors were correlated with health scores showing improvement. For example, the system may recognize which changes in factor values are most strongly correlated with health improvements. The analysis may be performed, for example, using a machine learning algorithm to detect such correlations. The system may recognize single factors in isolation that are correlated with health improvements. That is, the system may recognize that within the identified cohort members, walking twice a week or taking two vacations a year was correlated with a health improvement. The system may additionally recognize combinations of factors, when found in combination, that are correlated with health improvements. That is, the system may recognize that within the identified cohort members, going on one walk per week and meditating for 30 minutes each day leads to a health improvement. In addition to recognizing individual and combinations of factors correlated with health improvement, the system may also patterns or sequences of factors correlated with health improvement. For example, the system may recognize that sleeping at least 6 hours a day, followed by a 30 minute walk, followed by listening to classical music is correlated with positive health changes. By evaluating the health vectors for the identified cohort members, the system may recognize any confluence of factors that are correlated with sustained health improvements. Though the health vectors encompass both direct and contextual factors, the system only evaluates the contextual factors for correlation with health improvements. The system may also determine a strength of correlation for each of the factors. The strength of correlation is determined by comparing the presence of each factor with the amount of corresponding uplift in the outcome. Factors causing a more pronounced positive outcome are weighted more heavily than factors causing a less pronounced positive outcome.

At a block 425, the system ranks the identified factors. For example, the system may rank more highly those factors with a higher strength of correlation to the positive health change. As a further example, the system may rank higher those factors that were seen more frequently across the identified cohort members—that is, the factors that a greater number of cohort members changed and then subsequently experienced a positive health change. As an additional example, the system may rank higher those factors with a greater difference from the present values of the factors for the individual. For example, if the identified cohort members showed equivalent improvements to health whether caused by meditating 30 minutes each day or by going on four walks a week, and the individual already meditates 20 minutes each day but goes on no walks, then the system may prioritize the recommendation to go on four walks a week. As a further example, the identified factors may be ranked based on data indicating how effective past recommendations directed to the identified factors have been. For example, the system may receive data indicating whether a population member adopted a recommended change, and if so, whether the change in factor was effective for improving health. The system may rank factors based on observed efficacies, either within the associated cohorts or the entire population, for recommendations directed to the factor.

The rankings performed at block 425 may additionally comprehend characteristics of the cohorts associated with the individual. For example, if the individual is associated with a cohort of overly sedentary individuals, then recommendations that include increased movement would be ranked higher. As an additional example, if the individual is associated with a cohort of low mobility individuals, the ranking for recommendations requiring high mobility would be reduced and the low mobility recommendations would be ranked higher. As a further example, if the individual is associated with a cohort characterized as being motivated by money, a recommendation that includes a monetary reward would be more highly ranked.

FIG. 4C illustrates a table 470 of example contextual factors identified by the system as having a positive heath impact for an individual. The table includes contextual factors 470 and a recommendation confidence 480. The recommendation confidence 480 may be based on a number of aspects evaluated by the system, such as the strength of correlation, the frequency of occurrence by cohort members, the extent to which the health improvement was sustained, the effectiveness of prior recommendations directed to the factor, etc. For example, the table 470 includes going on three runs a week as an identified contextual factor. Going on three runs a week may be strongly correlated with an improved health in the cohort, but the system may have identified that members of the cohort typically cannot sustain running that frequently per week and that as a result the health improvement is lost. Accordingly, the system may assign only a 40% confidence that the recommendation of running three times a week would lead to a consistent health improvement for the individual. As a further example, table 470 includes skydiving once a year as an identified contextual factor. The system may have identified that skydiving annually is strongly correlated with a positive health change, but that it has a low frequency of occurrence (e.g., only one cohort member went skydiving). Accordingly, the system may assign only a 3% confidence. In contrast, the table 470 also includes as an example factor going on a 30 minute walk in the park each week. The system have identified that such an activity is frequently found in the cohort, is sustainable, and that prior recommendations made to the monitored population to go on 30 minutes walks have been effective, and therefore assigned a recommendation confidence of 88%. As described herein, the system may use the recommendation confidence to rank factors, to compare against a threshold for determining which factors are eligible for recommending, etc.

At a block 430, the system selects the recommendations to be provided to the individual. The system may select a fixed number of factors from the generated ranked list of factors. The system may also select all factors associated with a recommendation confidence score that exceeds a threshold value.

At a block 435, the system provides the selected recommendations to the individual. Recommendations may be provided electronically, such as through an email or SMS message to the individual or a notification in an application running on a smart watch or smartphone of the individual's. Recommendations may be provided over the phone, such as through an operator of the system calling the individual on the telephone to convey recommendations. It will be appreciated that other mechanisms may be used to convey the system-determined recommendations to the individual. After the recommendations are provided to the individual, the process returns.

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/we claim:

1. A computer-implemented method for providing a health recommendation for an individual, the method comprising:
retrieving a plurality of health vectors and a plurality of health score trends, each health vector and health score trend being associated with a member of a population,
wherein each health vector is comprised of a time-series of health factors characterizing the associated population member, and
wherein the health score trend is comprised of a time-series of health scores characterizing the health of the associated population member;
identifying, from the retrieved health vectors, the health vector associated with an individual;
associating, based on the individual health vector and the population health vectors, a cohort of population members with the individual;
identifying, based on the health score trends associated with the cohort and the individual health score trend, members within the cohort that are similarly health-situated to the individual;
analyzing the health score trends associated with the similarly health-situated cohort members for positive health outcomes;
determining, based on the positive health outcomes and the health vectors associated with the similarly health-situated cohort members, health factors correlated with the positive health outcomes; and
providing a recommendation to the individual based on a selected health factor correlated with the positive health outcomes.

2. The method of claim 1, further comprising extending a health vector associated with a population member based on monitoring the health factors characterizing the population member.

3. The method of claim 2, wherein the health factors are direct factors and contextual factors.

4. The method of claim 1, wherein a health score is generated by evaluating a health vector with a health assessment model.

5. The method of claim 4, further comprising normalizing the health score to a range.

6. The method of claim 1, wherein the health score trend associated with a population member is generated based on evaluating the health vector associated with population member at different times.

7. The method of claim 1, further comprising generating the cohort, wherein the cohort is generated by:
identifying a cluster of population health vectors;
generating a cohort health vector based on the cluster of population health vectors; and
constructing the cohort with the population members associated with the cluster of population health vectors.

8. The method of claim 7, wherein the association of the cohort with the individual is based on whether the cohort health vector is within a proximity of the individual health vector.

9. The method of claim 8, wherein the association of the cohort with the individual comprises
identifying a second cohort previously associated with the individual;
evaluating the number of health vectors belonging to the second cohort to determine whether the number of health vectors exceeds a threshold; and
relaxing, based on the evaluation of the number of health vectors, the proximity when the number of population health vectors is less than the threshold.

10. The method of claim 8, wherein the association of the cohort with the individual comprises
identifying a second cohort previously associated with the individual;
evaluating the health score trends belonging to the second cohort for a sufficient mix of second cohort members with improving and declining health changes; and
relaxing, based on the evaluation of the mix of improving and declining health changes, the proximity.

11. The method of claim 1, wherein the similarly health-situated cohort members are identified by:
selecting a window of the individual health score trend;
performing a sliding-window comparison between the cohort health score trends and the selected window of the individual health score trend; and
identifying matches between the window of the individual health score trend and the sliding window.

12. The method of claim 11, wherein the selected window includes the most recent health score of the individual.

13. The method of claim 11, wherein a positive health outcome for a similarly health-situated cohort member is determined based on changes to the health score of the member near a location associated with the sliding-window match.

14. The method of claim 1, further comprising:
ranking, prior to providing the recommendation to the individual, the health factors correlated with positive health outcomes by:
determining a strength of correlation associated with each health factor;
determining a frequency of occurrence associated with each health factor;
determining a positive health outcome slope associated with each health factor;
determining an effectiveness of adoption associated with each factor; and
ranking each health factor based on the associated strength of correlation, frequency of occurrence, positive health outcome slope, and effectiveness of adoption.

15. A non-transitory computer-readable medium containing instruction configured to cause one or more processors to perform a method for providing a health recommendation for an individual, the method comprising:
retrieving a plurality of health vectors and a plurality of health score trends, each health vector and health score trend being associated with a member of a population,
wherein each health vector is comprised of a time-series of health factors characterizing the associated population member, and
wherein the health score trend is comprised of a time-series of health scores characterizing the health of the associated population member;
identifying, from the retrieved health vectors, the health vector associated with an individual;
associating, based on the individual health vector and the population health vectors, a cohort of population members with the individual;
identifying, based on the health score trends associated with the cohort and the individual health score trend, members within the cohort that are similarly health-situated to the individual;
analyzing the health score trends associated with the similarly health-situated cohort members for positive health outcomes;
determining, based on the positive health outcomes and the health vectors associated with the similarly health-situated cohort members, health factors correlated with the positive health outcomes; and
providing a recommendation to the individual based on a selected health factor correlated with the positive health outcomes.

16. The non-transitory computer-readable medium of claim 15, further comprising extending a health vector associated with a population member based on monitoring the health factors characterizing the population member.

17. The non-transitory computer-readable medium of claim 16, wherein the health factors are direct factors and contextual factors.

18. The non-transitory computer-readable medium of claim 15, wherein a health score is generated by evaluating a health vector with a health assessment model.

19. The non-transitory computer-readable medium of claim 18, further comprising normalizing the health score to a range.

20. The non-transitory computer-readable medium of claim 15, wherein the health score trend associated with a population member is generated based on evaluating the health vector associated with population member at different times.

21. The non-transitory computer-readable medium of claim 15, further comprising generating the cohort, wherein the cohort is generated by:
identifying a cluster of population health vectors;
generating a cohort health vector based on the cluster of population health vectors; and
constructing the cohort with the population members associated with the cluster of population health vectors.

22. The non-transitory computer-readable medium of claim 21, wherein the association of the cohort with the individual is based on whether the cohort health vector is within a proximity of the individual health vector.

23. The non-transitory computer-readable medium of claim 22, wherein the association of the cohort with the individual comprises
identifying a second cohort previously associated with the individual;
evaluating the number of health vectors belonging to the second cohort to determine whether the number of health vectors exceeds a threshold; and
relaxing, based on the evaluation of the number of health vectors, the proximity when the number of population health vectors is less than the threshold.

24. The non-transitory computer-readable medium of claim 22, wherein the association of the cohort with the individual comprises
identifying a second cohort previously associated with the individual;
evaluating the health score trends belonging to the second cohort for a sufficient mix of second cohort members with improving and declining health changes; and
relaxing, based on the evaluation of the mix of improving and declining health changes, the proximity.

25. The non-transitory computer-readable medium of claim 15, wherein the similarly health-situated cohort members are identified by:
selecting a window of the individual health score trend;
performing a sliding-window comparison between the cohort health score trends and the selected window of the individual health score trend; and
identifying matches between the window of the individual health score trend and the sliding window.

26. The non-transitory computer-readable medium of claim 25, wherein the selected window includes the most recent health score of the individual.

27. The non-transitory computer-readable medium of claim 25, wherein a positive health outcome for a similarly health-situated cohort member is determined based on changes to the health score of the member near a location associated with the sliding-window match.

28. The non-transitory computer-readable medium of claim 15, further comprising:
ranking, prior to providing the recommendation to the individual, the health factors correlated with positive health outcomes by:
determining a strength of correlation associated with each health factor;
determining a frequency of occurrence associated with each health factor;
determining a positive health outcome slope associated with each health factor;
determining an effectiveness of adoption associated with each factor; and
ranking each health factor based on the associated strength of correlation, frequency of occurrence, positive health outcome slope, and effectiveness of adoption.

29. The non-transitory computer-readable medium of claim 15, wherein at least one of the plurality of health vectors is further comprised of a time-series of contextual health scores for the associated population member.
